(19) United States
(12) Patent Application Publication
(10) Pub. No.: US 2016/0272513 A1
(43) Pub. Date: Sep. 22, 2016

(54) BRINE MINING PROCESS

(71) Applicants: BLUE CUBE IP LLC, Midland, MI (US); HYDRATION SYSTEMS, LLC, Scottsdale, AZ (US)

(72) Inventors: Kurt Garbade, Stade (DE); Audra Veri Senkevich, Moon Township, PN (US); Max Markus Tirtowidjojo, Lake Jackson, TX (US)

(73) Assignee: BLUE CUBE IP LLC, Midland, MI (US)

(21) Appl. No.: 15/030,107

(22) PCT Filed: Oct. 17, 2014
(86) PCT No.: PCT/US2014/061183

§ 371 Date: Apr. 18, 2016

Related U.S. Application Data
(60) Provisional application No. 61/893,040, filed on Oct. 18, 2013.

(51) Int. Cl. C02F 1/44; C02F 1/46; B01D 61/58; C02F 1/467; C02F 1/42; C01D 3/06; B01D 61/00; C25B 9/08; C25B 1/26; C25B 15/08; C25B 1/36; C25B 1/46; B01D 71/16; C02F 9/00

(52) U.S. Cl. CPC C02F 1/445; B01D 71/16; C02F 1/4604; B01D 61/58; C02F 1/441; C02F 1/4674; C02F 1/42; C02F 9/00; B01D 61/005; C25B 9/08; C25B 1/26; C25B 15/08; C25B 1/36; C25B 1/46; C01D 3/06; C02F 2103/10

(57) ABSTRACT

The present invention relates to a brine mining process. The process incorporates a forward osmosis step wherein at least a portion of at least one process stream is provided to at least one forward osmosis unit. The process thus allows for the use of multiple sources, and qualities, of water, which, in turn, can reduce the reliance on natural water sources. Longevity of the mining, and any downstream, process equipment may be enhanced. At least a portion of the production stream may also be fed to a downstream process, such as a chlor-alkali process.

### CROSS-REFERENCE TO RELATED APPLICATIONS

This application claims the benefit of U.S. Provisional Application No. 61/893,040, filed Oct. 18, 2013.

### FIELD

The present invention relates to a brine mining process incorporating forward osmosis.

### BACKGROUND

For larger manufacturers, production of their own raw materials may be a more economical alternative to purchasing them from suppliers. Producers of chlorinated chemicals, for example, use large quantities of chlorine in the manufacture of their products. Production of this raw material in-house can not only provide cost savings, but also can minimize or eliminate issues that may be presented by transporting such materials.

Chlorine may typically be produced by electrolysis of a solution comprising large amounts of chloride in water, e.g., an aqueous sodium chloride solution. In some instances, manufacturers desirous of producing their own chlorine may purchase sodium chloride, produce a solution using the same, and then subject the produced solution to electrolysis to produce chlorine. Rather than purchasing one raw material to produce another, many manufacturers, and in particular, those with large chlorine requirements, may utilize brine mining to generate a salt solution, or brine, from salt deposits that may typically be from hundreds to thousands of feet below the earth's surface.

However, brine mining is not without its own costs and challenges. For one, to maximize efficiency, plants for the production of the downstream products are desirably located in close proximity not only to the deposit to be mined, but also to a water source capable of providing the large amounts of water required, e.g., wells, rivers, lakes or an ocean, etc. Even with such a location, in times of water shortage or drought, available water volume may fall short of that desired to maintain operation of the brine mine.

Even if the desired water volume is available from natural water sources, such water is not always free of contaminants harmful to the brine mining, or downstream, process equipment and/or yield. And so, purification steps may be required to minimize damage that can result from the use of unpurified water. Even so, the desired purity can be difficult to achieve in water from a natural resource. Damage to equipment can also ensue from the precipitation of salt crystals from the produced fluid. Care must be taken to balance the desire to extract the maximum amount of salt from the mine while avoiding the cost of cleaning equipment that has become fouled or clogged from such precipitation.

Finally, brine mining also requires that one or more bore holes be drilled to the salt deposit. The drilling of each bore hole can cost tens of millions of dollars, and pumps capable of applying the pressure needed to inject the injection fluid and withdraw the saturated solution are not inexpensive. And so, while increasing the number of bore holes and/or increasing bore hole diameter can increase the amount of water provided to, and brine withdrawn, from the mine, the number of bore holes and the diameter thereof, and equipment required to move water and solution in and out of them, may desirably be kept to a minimum.

There is thus a need for brine mining processes wherein the efficiency thereof is maximized, without compromising the mining, or downstream process, equipment. Such processes would provide additional advantages to the art if they allowed for the use of alternative water sources and/or a reduced reliance on natural resources.

### BRIEF DESCRIPTION

The present invention provides such a process. More particularly, the present brine mining process incorporates a forward osmosis step. The concentration of the salt of interest, or one or more contaminants, may be reduced in the process stream so treated, and so the stream rendered more suitable for introduction, or reintroduction, into the mine, or for use in downstream processes. The use of forward osmosis in a brine mining process, as compared to other purification techniques, is advantageous in that it can require less expenditure in utility costs than, e.g., reverse osmosis. And, some purification techniques, including reverse osmosis, can require the application of high pressure, which in turn, requires the use of expensive pumps and other equipment to apply and accommodate it. Reliance on natural resources may also be reduced in some embodiments by reusing the process stream treated by forward osmosis within the process.

In one aspect of the present invention, a brine mining process is provided. The process comprises providing at least a portion of at least one brine mining process stream to at least one forward osmosis unit. Process streams to be provided to the forward osmosis unit could be, for example, spent anolyte which is a brine stream depleted of some salt (such as sodium chloride) as may be discharged from the cells of a membrane electrolysis process or a diaphragm cell, or a brine stream requiring some treatment, such as removal of organics or compounds that may cause scaling within the process equipment, before being provided to the forward osmosis unit. Such additional treatment may comprise, e.g., reverse osmosis, electrochemical reaction, ion exchange, dilution, filtration, or a combination of any number of these. Whatever the specific composition of the product stream, and whether or not subjected to any treatment, it may be used as a feed stream, draw stream, or a combination of these, or the feed and/or draw stream may comprise fresh water, salt water, one or more aqueous process streams from the same, or one or more different process(es), or a combination of these. The process stream so treated can be reintroduced into the brine mine, provided to a downstream process, such as a chlor-alkali process, reintroduced to the at least one forward osmosis unit, or combinations of these.

The brine mining process stream may be fed to multiple forward osmosis units, and in such embodiments, may be fed to the units serially or in parallel or combinations thereof. Further, in embodiments wherein the feed and draw solutions are provided in series to the multiple forward osmosis units, the flow of the feed and draw solutions relative to one another, and between the units, is arranged to be counter-current.

At least one of the forward osmosis units desirably comprises more than one forward osmosis membrane. Indeed, the number of membranes within each unit can be adjusted to accommodate the flow of feed and/or draw solution to the unit. In other embodiments, the flow to the units/membranes can be adjusted by purging any amount of the feed or draw, as the case may be.

The feed or draw stream may be subjected to an additional treatment step if desired, and any such additional treatment may occur before or after the forward osmosis step. The additional treatment step may comprise, e.g., reverse osmosis, electrochemical reaction, ion exchange, dilution, filtration, or a combination of any number of these.

The brine may comprise any salt desirably obtained by brine mining, e.g., sodium chloride, potassium chloride, magnesium chloride, sodium carbonate, sodium bicarbonate, sodium sulfate, or combinations of these. Because of its importance in the production of, e.g., chlorine, the brine may desirably comprise sodium chloride or potassium chloride.

### BRIEF DESCRIPTION OF THE DRAWINGS

These and other features, aspects, and advantages of the present invention will become better understood when the following detailed description is read with reference to the accompanying drawings, wherein:

FIG. 1 shows a schematic representation of a brine mining process according to one embodiment;

FIG. 2 shows a schematic representation of one embodiment of the present process wherein the feed and draw solution are fed in parallel to a forward osmosis unit having multiple membranes;

FIG. 3 shows a schematic representation of one embodiment of the present process wherein the feed and draw solution are fed in series to multiple forward osmosis units with a counter-current flow between the units; and

FIG. 4 shows a schematic representation of one embodiment of the present process wherein the feed is fed in parallel to multiple forward osmosis units and the draw is fed in series to multiple forward osmosis units with counter-current flow between the units.

FIG. 5 shows a schematic representation of one embodiment of the present process wherein the feed is fed in both parallel and series to multiple forward osmosis units and the draw is fed in series to multiple forward osmosis units with counter-current flow between the units.

### DETAILED DESCRIPTION

The present specification provides certain definitions and methods to better define the present invention and to guide those of ordinary skill in the art in the practice of the present invention. Provision, or lack of the provision, of a definition for a particular term or phrase is not meant to imply any particular importance, or lack thereof. Rather, and unless otherwise noted, terms are to be understood according to conventional usage by those of ordinary skill in the relevant art.

The terms “first”, “second”, and the like, as used herein do not denote any order, quantity, or importance, but rather are used to distinguish one element from another. Also, the terms “a” and “an” do not denote a limitation of quantity, but rather denote the presence of at least one of the referenced item, and the terms “front”, “back”, “bottom”, and/or “top”, unless otherwise noted, are merely used for convenience of description, and are not intended to limit the part being described limited to any one position or spatial orientation.

If ranges are disclosed, the endpoints of all ranges directed to the same component or property are inclusive and independently combinable (e.g., ranges of “up to 27 wt. %, or, more specifically, 5 wt. % to 20 wt. %,” is inclusive of the endpoints and all intermediate values of the ranges of “5 wt. % to 27 wt. %,” etc.). As used herein, percent (%) conversion is meant to indicate change in molar or mass flow of reactant in a reactor in ratio to the incoming flow, while percent (%) selectivity means the change in molar flow rate of product in a reactor in ratio to the change of molar flow rate of a reactant.

As used herein, the phrase “forward osmosis unit” means a collection of equipment for carrying out a forward osmosis process, including at least one forward osmosis membrane, and optionally further comprising equipment for carrying out any treatment to be carried out on the draw or feed solutions either before or after the provision thereof to the forward osmosis membrane, measurement devices, e.g., for the measurement of flowrates, pressures, temperatures, pH, conductivity, etc., pumps, tanks, and pipework for internal or external interconnections. Any or all of the controllable elements of the forward osmosis unit may be controlled by a programmable logic controller (“PLC”), and if used, the PLC may be considered to be part of the forward osmosis unit. The phrase “forward osmosis membrane” is meant to indicate each individual membrane within the forward osmosis unit. The phrase “brine mining process stream” means any process stream used in, or ancillary to, a brine mining process, and can include, for example, spent anolyte stream, e.g., such as a brine stream at a lower sodium chloride concentration than saturation as may be discharged from the cells of a membrane electrolysis process or a diaphragm cell, or a brine stream requiring some treatment, such as removal of organics or compounds that may cause scaling within the process equipment, before being provided to the forward osmosis unit.

There is provided a brine mining process wherein at least a portion of at least one process stream from, or ancillary to, a brine mining process is provided to at least one forward osmosis unit. The process stream may be utilized as a draw solution, in which case, the concentration of the salt of interest, and in some embodiments, one or more contaminants, may be reduced in the process stream so treated, and so the stream rendered more suitable for introduction, or reintroduction, into the mine, or for use in downstream processes. That is, the forward osmosis membrane may typically reject many or a portion of the contaminants present in the feed solution, while allowing the passage of water, and as a result, the concentration of impurities in the feed solution exiting the forward osmosis unit may increase, and with the passage of clean water into the draw solution, the concentration of impurities and contaminants therein will become more dilute.

Because the draw solution has had the salt concentration therein reduced, it is suitable for use to absorb additional quantities of the salt of interest via reintroduction into the mine. Because the concentration of many contaminants within the production stream so treated has been reduced via the dilution of the production stream, the production stream becomes more useable in downstream processes. Additionally, whereas feeding contaminated water into a brine mine will result in contaminated brine, and thus a contaminated production stream, the use of cleaner water results in a cleaner production stream. In some embodiments, the treated stream may be reintroduced into the forward osmosis unit, or introduced into further forward osmosis units as a draw stream, while the feed solution in such embodiments may comprise streams from other processes. In such embodiments, the draw stream may effectively act to recover water from spent process streams, thereby reducing the reliance on natural resources.

The use of forward osmosis in a brine mining process, as compared to other purification techniques, is advantageous in that it can require less expenditure in utility costs than, e.g., reverse osmosis. And, some purification techniques, including reverse osmosis, can require the application of high pressure, which in turn, requires the use of expensive pumps and other equipment to apply and accommodate it. Reliance on natural resources may also be reduced in some embodiments by reusing the process stream treated by forward osmosis within the process.

Even though such advantages can be provided, forward osmosis has not been provided in conjunction with brine mining processes conventionally. Rather, evaporation or salt solubilization have been utilized in order to reconcentrate draw solutions used in conventional forward osmosis processes, presumably because those of ordinary skill in the art either didn't consider use of a brine mine for this purpose, or perhaps because providing a brine mine for this sole purpose was considered too costly. Similarly, conventional brine mining processes have typically not incorporated therein purification processes, as those of ordinary skill in brine mining are reluctant to add to the cost of an already costly process. Furthermore, prior to the disclosure herein, there had been no known process of combining forward osmosis with brine mining in a way so that the production capacity of the brine mine was met, while yet accommodating the same with any purification method, much less forward osmosis. It has now been surprisingly discovered that a forward osmosis process may be provided in combination with a brine mining process, not only cost effectively, but in a way so that the brine mining production requirements are met.

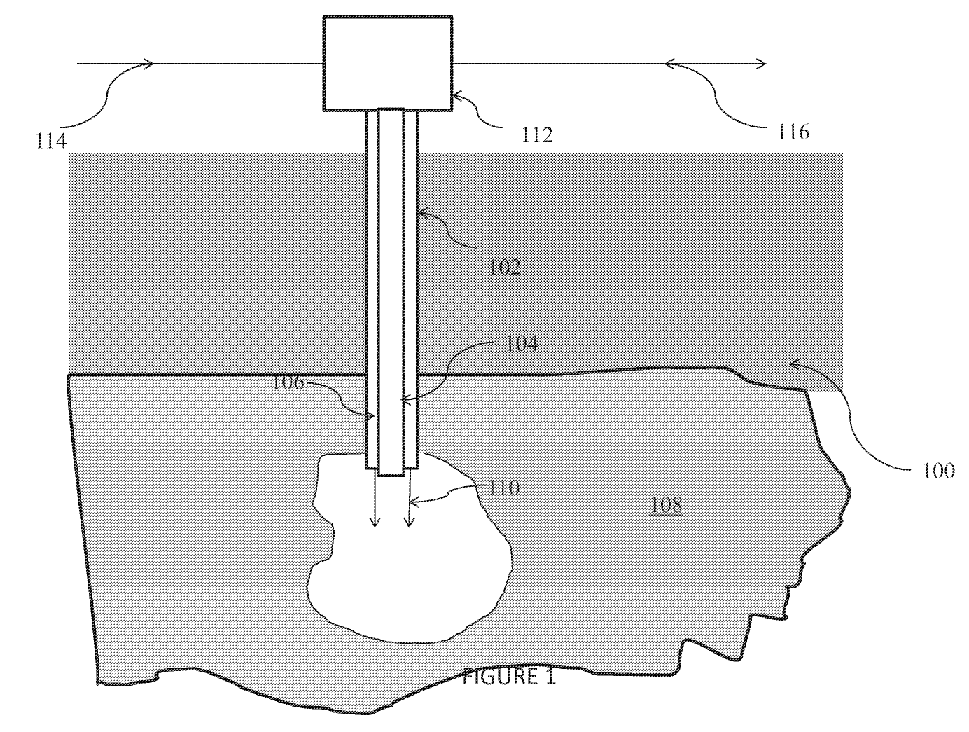

One example of a brine mine into which a forward osmosis step may be incorporated is shown schematically in FIG. 1. In brine mine 100, a bore hole is drilled to, or within proximity of, a deposit 108 of the salt to be mined and a casing 102 provided there through. Cement (not shown) may be pumped around casing 102 to seal the annular space between the wall of the earthen bore hole and casing 102. An injection well head (not shown), as may be provided within housing 112, provides access to casing 102, as well as a connection point. An inner pipe 104 is provided within casing 102, providing annular space 106 between the inner surface of casing 102 and the outer surface of inner pipe 104. Annular space 106 serves as an injection conduit, while inner pipe 104 serves as a conduit for the production stream from the mine.

In operation, an injection stream 114 is introduced into the mine through annular space 106. Any aqueous fluid may be used, and those of ordinary skill in the art are familiar with many. Exemplary injection fluids could be from natural sources, or synthetic processes, and as such, may comprise salt or fresh water, and aqueous process streams from the same, or different chemical processes, such as spent process streams, waste streams, byproduct streams, etc.

The injection stream flows from annular space 106 into salt deposit 108 and forms a brine having a concentration of the salt dissolved therein. A production stream of the brine is then withdrawn through inner pipe 104 and may be provided to one or more downstream processes via conduit 116.

The particular configuration of the brine mine is not critical, and those of ordinary skill in the art of brine mining are familiar with the equipment and techniques utilized in connection therewith, and any of these, in any configuration, may be used in the present process. For example, although a single bore hole is shown in FIG. 1, multiple bore holes may be used, e.g., one or more conduits may be provided for the injection of aqueous solution and one or more separate conduits provided for withdrawal of brine. Or, a larger diameter bore hole may be drilled and two separate conduits provided within the same well bore. In other embodiments three or more pipes may be provided concentrically through a single bore hole to allow separate injection of, e.g., additional solvents, mine treatment agents, fluid blankets, etc. into, or on top of deposit 108. Due to the large expense that may be associated with the provision of each bore hole, configurations in which only one bore hole is utilized may be preferred, and those wherein the injection conduit is the annular space provided by the casing 102 and inner pipe 104 may be particularly preferred.

Rather, all that is required in the present process is that at least a portion of at least one stream used within, or ancillary to, the brine mining process is provided to at least one forward osmosis unit. That is, at least a portion of, e.g., the injection stream or production stream, or both, may be provided to the forward osmosis unit. Further, in those embodiments wherein at least a portion of the production stream is treated by the forward osmosis unit, it may be reintroduced into the mine, thereby becoming at least a portion of the injection stream. Or, in other embodiments, the treated portion of the production stream may be provided to a downstream process. In other words, the categorization of the process stream herein, for convenience and clarity sake only, is defined from the point in time of its provision to the forward osmosis unit, not how it is to be used thereafter. As those of ordinary skill in the art understand, as the process operates, a portion of a process stream may be used as an injection stream, recovered as a production stream, provided to a downstream process and/or reintroduced into the brine mine as an injection stream, or combinations of any number of these.

The forward osmosis unit comprises at least one, desirably semi permeable, membrane having a draw side, and a feed side. In operation, a feed stream is caused to contact the feed side of the membrane, and a draw stream, desirably having an osmotic pressure higher than the feed solution, is caused to contact the draw side of the membrane. Although the flow of draw versus feed solution may be caused to be co- or counter current relative to each other, typically, the draw solution is circulated on the permeate side of the membrane as the feed stream is passed by the feed side, so that the relationship of the flow of draw to feed solution is more complex.

However, no matter what the relationship of the flows of feed and draw solution, so long as the osmotic pressure of on the draw side of the membrane, as may typically be provided by the draw stream, is higher than the osmotic pressure on the feed side of the membrane, water will diffuse from the feed side through the membrane and to the draw side, thereby diluting the draw stream. Stated another way, the draw solution thus causes water to pass through the membrane from the feed stream, while the membrane rejects many of the impurities or contaminants present therein. Advantageously, the application of additional pressure is not required, and so, significant costs savings are provided over purification techniques that require the same, e.g., reverse osmosis.

In order to maintain the osmotic pressure differential in light of this dilution, the draw solution may typically be reconcentrated, or otherwise replenished, during use. In conventional forward osmosis processes, the draw solution is reconcentrated via mixing purchased solid salt therein, or by evaporation techniques. Such conventional reconcentration methods may, in fact, typically consume most of the energy needed to operate the forward osmosis unit. Reconcentrating the draw solution via introduction into an existing brine mine can not only be more expedient, but does not require additional significant capital cost for evaporation equipment and/or operating cost in raw materials and required energy.

The incorporation of the forward osmosis process into a brine mining process allows water from a variety of sources to be used, or considered for use, that absent the forward osmosis process, would not be considered acceptable alternatives due to contaminant levels. Derivation of water from these alternative sources, e.g., spent process streams from other processes, sea water, etc., provides a flexibility in processing alternatives that may render a brine mining process suitable in an environment where water shortage can occur.

Any suitable membrane may be used in the forward osmosis units, and more than one membrane, and combinations of different suitable membranes, may be used. Those of ordinary skill in the art are aware of many, including, e.g., those commercially available from DuPont®, Eastman Chemical Company, The Dow Chemical Company and Hydration Technology Innovations (“HTI”). In particular, since membranes used in forward osmosis may typically be similar to those used in reverse osmosis, membranes known to be suitable for use in reverse osmosis processes may also be used. Selection of an appropriate membrane may typically involve selecting a membrane that rejects, i.e., prevents from crossing from the feed side to the draw side of the membrane, at least the salt of interest as well as various organic and/or inorganic contaminants.

The suitable membrane or membranes may further be provided in any configuration. That is, the membrane(s) utilized may be tubular, hollow fiber, flat, or spiral wound, and if flat, may be provided as individual membranes within the unit, or may be connected together, with or without and outer casing, i.e., multiple membranes may be provided as a cassette. The membranes may or may not be reinforced, as desired. Flat membranes may be of any suitable size and shape, i.e., may be rectangular, circular, semicircular, etc. If membranes having an active surface are utilized, the active surface thereof is desirably oriented to be contacted by the feed stream.

If multiple membranes are used, flow channels distributing the feed or draw solutions to the membranes may be provided there through, desirably in a fashion so as to minimize the pressure drop, i.e., to less than 200 psi, or 150 psi, or 100 psi, or 50 psi, or even less than 25 psi, between the inlet and the outlet of the forward osmosis unit. The flow channels may also serve to provide support to the membranes. Suitable singular, or multiple, inlets and outlets are also provided. In those embodiments wherein spiral wound membranes are desirably used, the draw stream may be introduced into a central inlet tube, and thereafter provided into flow channels provided between the membrane layers through holes provided in the central inlet tube. Furthermore, if multiple membranes are to be used, they need not be of the same type—i.e., combinations of flat and spiral wound membranes may be used, combinations of different sizes or membranes having a different specific water flow rates through the membrane per unit area (referred to as flux rates) may be used, etc.

As with the particulars of the brine mining process, the particular features and operating parameters of the forward osmosis unit are not critical, and any number of forward osmosis units in any configuration, comprising any number and/or type of membranes, in any configuration, may be utilized. Those of ordinary skill in the art of forward osmosis are well aware of the options available to them in setting up and operating forward osmosis equipment, and how to select from them without undue experimentation. Rather, the benefits of the present invention are expected to be seen by providing at least a portion of at least one stream from a brine mining stream to at least one forward osmosis unit. As described above, doing so will allow for the use of a water source that may otherwise have suboptimal purity for use in a brine mining, or downstream, process. Additionally, the use of the brine mine to reconcentrate the forward osmosis draw solution can provide an expedient and cost effective method of doing so, as compared to conventional methods of reconcentration.

The aforementioned notwithstanding, and in light of the capital and installation costs associated with new brine mining equipment, or modifying existing brine mining equipment, the particular forward osmosis unit(s), membranes, configurations thereof and operating parameters of the same may desirably be selected based at least in part on the input and output requirements of the brine mine, rather than vice versa. That is, each bore hole provided in a brine mine has a flow capacity that is dictated, at least in part, by its internal diameter. Whereas a bore hole having a relatively small internal diameter may be capable of accommodating a flow rate of 20 tons per hour, but yet require a lower initial capital and operating cost expenditure, a bore hole considered large in relation thereto may be able to accommodate a flow rate of 5000 tons per hour, but also require a higher capital and operating cost expenditure. Although forward osmosis units and or membranes are not inexpensive, they are less expensive than drilling new, or modifying existing, bore holes. And so, the forward osmosis process equipment, configuration and parameters may desirably be selected to provide and/or accommodate the flow rate, and/or salt concentration to and from the brine mine, rather than installing or modifying existing brine mining equipment to provide a certain flow and concentration to the forward osmosis unit(s).

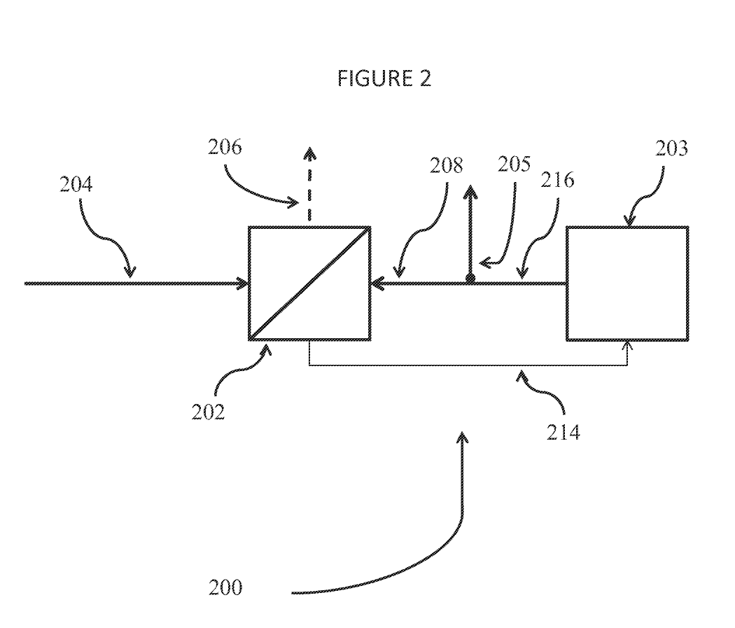

Those of ordinary skill in the art of forward osmosis are capable of determining and/or manipulating the number, type, configuration and processing parameters of forward osmosis units and membranes that will accommodate and existing or intended brine mining operation without undue experimentation. With FIGS. 2-4, Applicants have provided some alternative installations, based upon assumed exemplary brine mining input and output requirements, but these are by no means representative of the brine mining/forward osmosis configurations within the scope of the present invention.

One exemplary forward osmosis step that may be incorporated into the brine mining process is shown in FIG. 2. As shown, forward osmosis process 200 makes use of forward osmosis unit 202, having feed stream inlet 204 operatively disposed relative to a source (not shown), and feed stream outlet 206. Draw stream inlet 208 and outlet 214 are also provided and are operably disposed relative to forward osmosis unit 202 and brine mine 203. Conduit 205 is also provided and may be used to provide at least a portion of a production stream 216 from brine mine 203 to a downstream process (not shown), such as a chlor-alkali process.

Forward osmosis unit 202 desirably comprises at least one forward osmosis membrane, and desirably, comprises more than one membrane, arranged so that both the feed and draw streams are provided to the membranes in parallel. For example, forward osmosis unit 202 may desirably comprise, greater than 10, or greater than 50, or greater than 100, or greater than 500, greater than 1000, greater than 10,000, greater than 20,000, or greater than 50,000 membranes. The membranes may be flat, or may be preferably provided in spiral wound configuration (not shown).

In operation of process 200, an aqueous feed stream is provided to the multiple membranes of forward osmosis unit 202 in a parallel configuration, i.e., forward osmosis unit 202 comprises multiple inlets (not shown) to provide a portion of the feed stream to each membrane such that they all experience the same salt or impurity concentration in the inlet stream to the feed side. A draw stream is provided through conduit 208 and similarly provides at least a portion of the draw stream to multiple inlets (not shown) within forward osmosis unit 202, i.e., so that the draw stream is also provided to the membranes within forward osmosis unit 202 in parallel such that they all experience the same salt concentration in the inlet stream to the draw side.

The feed stream provided via conduit 204 may be any aqueous stream having a lower osmotic pressure than that provided by the draw stream provided through conduit 208. For exemplary purposes, process 200 contemplates the use of sea water. Sea water may typically have a sodium chloride concentration of greater than 1%, or greater than 2% or greater than 3%. Typically, and although again not critical, sea water may have a salt concentration of about 3.5%.

The draw stream provided through conduit 208 will comprise the salt of interest, e.g., sodium chloride, typically at a concentration greater than that of the feed stream so that the osmotic pressure differential will allow the diffusion of water from the feed stream into the draw stream. The concentration of sodium chloride provided by conduit 208 may, e.g., typically be greater than 10%, or greater than 15%, or greater than 20%, or even greater than about 25% by weight. In some embodiments, the concentration of sodium chloride within the draw stream provided by conduit 208 may be 25.5% by weight.

Within forward osmosis unit 202, the feed solution contacts the forward osmosis membranes on the feed side thereof, while the draw stream contacts the forward osmosis membranes on the draw side thereof. As a result, water is drawn from the feed stream into the draw stream, while any impurities in the feed stream may be rejected by the membrane(s). And so, the concentration of salt in the feed stream exiting forward osmosis unit 202 via outlet 206 will be greater than the concentration within the feed stream as it enters forward osmosis unit 202 via inlet 204. Typically, the concentration of sodium chloride within the exiting feed stream will be greater than 3.5%, or greater than 3.6%, or greater than 3.7%, or greater than 3.8%, or greater than 3.9% or greater than 4%. In some embodiments of process 200, the concentration of sodium chloride within the feed stream exiting forward osmosis unit 202 via outlet 206 may be 4.1%.

Similarly, the concentration of salt in the draw stream exiting forward osmosis unit 202 via outlet 214 will be less than the concentration of salt in the draw stream as it enters forward osmosis unit 202. And so, the concentration of salt in the exiting draw stream may be less than 25%, or less than 24%, or less than 23% or less than 22%, or less than 20% or less than 18 percent, or less than 14% or less than 10%. In some embodiments of process 200, the concentration of sodium chloride within the draw stream exiting forward osmosis unit 202 via outlet 206 may be 17.5%.

For purposes of process 200, the draw stream flow rate provided by conduit 208 can vary within a wide range depending upon the particular brine mine configuration served by the forward osmosis unit, and in particular, may depend upon the available bore holes and sizes of the particular brine mine. The draw stream flow rate may also desirably depend upon the demands of downstream processes for process streams produced by the mine.

For example, a brine mine with 10 bore holes having a capacity of 13.8 tons per hour (t/h) and a desired production flow rate of 50 t/h of brine to downstream processes (e.g., stream 205), the desired flow rate of stream 208 to the forward osmosis unit 202 would be 88 t/h. On the other hand, a brine mine with 2 bore holes having a capacity of 3450 t/h and a desired production flow rate of 2,500 t/h of brine to downstream processes via line 205, the flow rate to unit 202 would be 4395 t/h.

As the draw stream draws water from the feed stream within forward osmosis unit 202, the water content, and desirably, the flow rate, thereof may increase within forward osmosis unit 202, so that the flow rate exiting via outlet 214 is greater than the flow rate of the draw stream 208 entering forward osmosis unit 202. This increase in water content/flow rate, may advantageously be used to provide the desired, or a sufficient, flow to brine mine 203 and downstream process(es) as fed by line 205.

For example, for the case where stream 205 desirably has a flow rate of 50 t/h with 25% salt content or 37.5 t/h water content, and the flow rate into forward osmosis unit 202 is 88 t/h, the flow rate into the brine mine 203 would be 125 t/h with a salt concentration of 17.5% or water content of 103 t/h (depending on the flux rate and size of the membrane).

For the case where stream 205 requires a flow rate of 2500 t/h with a 25% salt content, then the flow rate of the draw stream will increase from 4395 t/h and a salt content of 25% as it flows into forward osmosis unit 202 via line 208, to a flow rate of 6270 t/h and a salt content of 17.5% as it exits forward osmosis unit 202 via line 214.

For purposes of process 200, a flow rate of the feed stream through conduit 204 is provided that will supply the necessary amount of water into the draw stream as it exits forward osmosis unit to accommodate the requirements of brine mine 203 and the downstream process fed via line 205. Because the water content of the feed stream is decreasing, the flow rate thereof may decrease.

For example, for the case where stream 205 is required to have a flow rate of 50 t/h with 25% salt content, then the flow rate of the feed stream will decrease from 264 t/h and a salt content of 3.5% as it flows into forward osmosis unit 202 via line 204, to a flow rate of 226 t/h and a salt content of 4.1% as it exits forward osmosis unit 202 via line 206. For the case where stream 205 is required to have a flow rate of 2500 t/h with 25% salt content, then the flow rate of the feed stream will decrease from 13184 t/h and a salt content of 3.5% as it flows into forward osmosis unit 202 via line 204, to a flow rate of 11309 t/h and a salt content of 4.1% as it exits forward osmosis unit 202 via line 206. Line 206 may provide the exiting feed stream to other processes, or, may appropriately dispose of feed stream, as desired.

In process 200, the draw stream exiting forward osmosis unit 202 is introduced into brine mine 203 “neat”, i.e., without the addition of one or more other aqueous make-up streams. Such embodiments of process 200 thus provide for a reduction in reliance on outside sources for aqueous injection streams. In other embodiments, not shown in FIG. 2, the treated draw solution may be augmented by an aqueous stream from any other source, including natural resources, other or the same chemical process, etc.

The use of a forward osmosis configuration as shown by, or similar to, FIG. 2 can prove especially beneficial when the injection volume into an existing brine mine is not particularly limited, i.e., when the brine mine has a large, or readily expandable capacity. The configuration shown in FIG. 2 is also most advantageously employed when there is a use or suitable disposal site operably disposed relative to the mine to receive the volume of spent feed stream generated by the operation of process 200. FIG. 2 is also representative of a configuration in which the initial capital cost for the forward osmosis unit and membranes is minimized.

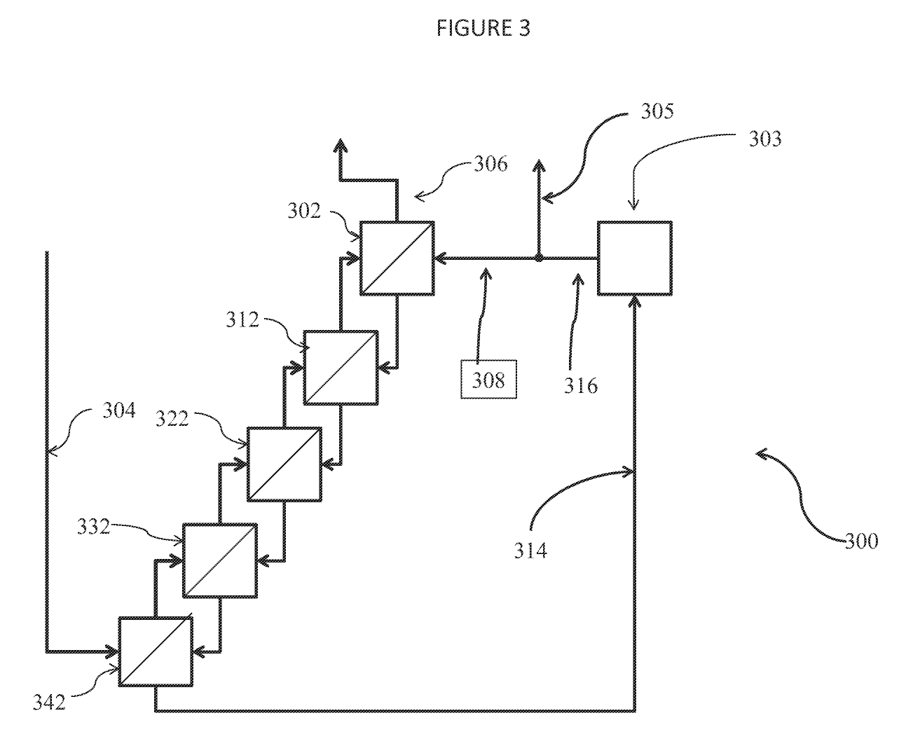

Another exemplary process is shown in FIG. 3. As shown, forward osmosis process 300 makes use of multiple forward osmosis units 302, 312, 322, 332 and 342. Process 300 thus differs from process 200 in that multiple forward osmosis units are used. Process 300 also shows the flow of both feed and draw streams being provided to the multiple forward osmosis units serially and the feed stream first contacting forward osmosis unit 342, while the draw stream first contacts forward osmosis unit 302, i.e., the flow of the feed and draw solutions to the forward osmosis units is counter-current.

In operation of process 300, an aqueous feed stream is provided to the forward osmosis unit 342. The feed stream provided via conduit 304 may be any aqueous stream having a lower osmotic pressure than that provided by the draw stream as it is provided to forward osmosis unit 342. For exemplary purposes, process 300 contemplates the use of sea water having a salt concentration of 3.5% as the feed stream.

A draw stream comprising at least a portion 308 of the production stream 316 from brine mine 303 is provided to forward osmosis unit 302. The draw stream will comprise the salt of interest, e.g., sodium chloride, typically at a concentration greater than that of the concentration of the salt within the draw stream within forward osmosis unit 302 so that the osmotic pressure differential will allow the diffusion of water from the feed stream into the draw stream. The concentration of sodium chloride within the draw stream may, e.g., typically be greater than 10%, or greater than 15%, or greater than 20%, or even greater than about 25%. In process 300, the concentration of sodium chloride within the draw stream is contemplated to be 25%.

Within each forward osmosis unit of process 300, the feed solution contacts the forward osmosis membrane(s) on the feed side thereof, while the draw stream contacts the forward osmosis membrane(s) on the draw side thereof. As a result, water is drawn from the feed stream into the draw stream, while any impurities in the feed stream may be rejected by the membrane(s). And, the concentration of salt in the feed stream exiting each forward osmosis unit 342, 332, 322, 312 and 302 will be successively greater than the concentration within the feed stream as it enters each unit. Similarly, the concentration of salt in the draw stream exiting forward osmosis unit 302, 312, 322, 332 and 342 will be successively less than the concentration of salt in the draw stream as it enters each unit.

As with process 200, the draw stream flow rate provided by conduit 308 may desirably depend upon the available bore holes and sizes of the particular brine mine being served by process 300. The draw stream flow rate may also desirably depend upon the demands of downstream processes for process streams produced by the mine To exemplify one end of a spectrum, production capacity of brine mine 303 can be assumed to be 31 t/h of brine, with downstream processes requiring 25 t/h of this production, so that flow through conduit 308 to forward osmosis unit 302 is 6 t/h. A larger capacity brine mine may produce, e.g., 62,600 t/h, of brine and desirably feed downstream processes 50000 t/h, thereby providing a flow through conduit 308 to forward osmosis unit 302 of 12,600 t/h.

As the draw stream draws water from the feed stream within each forward osmosis unit 302, 312, 322, 332 and 342 the water content, and desirably, the flow rate, thereof may increase within each forward osmosis unit 302, 312, 322, 332 and 342 so that the flow rate exiting via outlet 314 is greater than the flow rate of the draw stream entering forward osmosis unit 302 via conduit 308. The amount of water transferred, or flux rate, in each forward osmosis unit may depend, at least in part, on the concentration difference between the two sides of the membrane. And so, because the concentration difference is becoming smaller from forward osmosis unit to forward osmosis unit and the concentration of the feed, the flux rate will decrease from forward osmosis unit 302 to forward osmosis unit 342. For example, the flux rate can range from 40 l/(h*m²) down to zero, or from 20 to 6 l/(h*m²).

It is to be understood that the concentrations and flow rates provided herein are estimates only, based upon the properties of the contemplated membranes as implemented. Over time, the flux rates may change, due to fouling or physical changes of the membrane. Other membranes may exhibit greater flux rates and/or resistance to fouling, and/or regeneration of membranes may be possible, so that flux rates may vary over the life of the membranes. Any known membrane, membrane developed in the future, suitable for use in forward osmosis units may be used.

For the case where stream 305 desirably has a flow rate of 25 t/h with 25% salt content, then the flow rate of the draw stream will increase from 6 t/h and a salt content of 25% as it flows into forward osmosis unit 302, to a flow rate of 9 t/h and a salt content of 17.5% as it enters forward osmosis unit 312, to a flow rate of 12 t/h and a salt content of 12.8% as it enters forward osmosis unit 322, to a flow rate of 16 t/h and a salt content of 9.7% as it enters forward osmosis unit 332, to a flow rate of 21 t/h and a salt content of 7.6% as it enters forward osmosis unit 342. As it exits forward osmosis unit 342, the flow rate of the draw stream for this exemplary case may be 25 t/h, and the salt content thereof may be 6.3%.

For the case where stream 305 desirably has a flow rate of 50000 t/h with a 25% salt content, then the flow rate of the draw stream will increase from 12610 t/h and a salt content of 25% as it flows into forward osmosis unit 302, to a flow rate of 17980 t/h and a salt content of 17.5% as it enters forward osmosis unit 312, to a flow rate of 24700 t/h and a salt content of 12.8% as it enters forward osmosis unit 322, to a flow rate of 32600 t/h and a salt content of 9.7% as it enters forward osmosis unit 332, to a flow rate of 41300 t/h and a salt content of 7.6% as it enters forward osmosis unit 342. As it exits forward osmosis unit 342, the flow rate of the draw stream for this exemplary case may be 50110 t/h, and the salt content thereof may be 6.3%.

A flow rate of the feed stream is provided to forward osmosis units 332, 322, 312 and 302 that will supply the necessary water to the draw stream to accommodate the requirements of brine mine 303 and the downstream process(es) fed by line 305. Because the water content of the feed stream is decreasing, the flow rate thereof may decrease, or in some embodiments, may stay substantially the same.

For the exemplary embodiments where stream 305 desirably has a flow rate of 25 t/h with 25% salt content, then the flow rate of the feed stream will decrease from 62 t/h and a salt content of 3.5% as it flows into forward osmosis unit 342, to a flow rate of 59 t/h and a salt content of 3.8% as it enters forward osmosis unit 332, to a flow rate of 55 t/h and a salt content of 4.1% as it enters forward osmosis unit 322, to a flow rate of 51 t/h and a salt content of 4.4% as it enters forward osmosis unit 312, to a flow rate of 47 t/h and a salt content of 4.7% as it enters forward osmosis unit 302. As it exits forward osmosis unit 302, the flow rate of the feed stream for this exemplary case may be 45 t/h, and the salt content thereof may be 5.0%.

For the case where stream 305 desirably has a flow rate of 50000 t/h with a 25% salt content, then the flow rate of the feed stream will decrease from 123900 t/h and a salt content of 3.5% as it flows into forward osmosis unit 342, to a flow rate of 115090 t/h and a salt content of 3.8% as it enters forward osmosis unit 332, to a flow rate of 106400 t/h and a salt content of 4.1% as it enters forward osmosis unit 322, to a flow rate of 98490 t/h and a salt content of 4.4% as it enters forward osmosis unit 312, to a flow rate of 91780 t/h and a salt content of 4.7% as it enters forward osmosis unit 302. As it exits forward osmosis unit 302, the flow rate of the feed stream for this exemplary case may be 86400 t/h, and the salt content thereof may be 5.0%.

The number of forward osmosis membranes within each forward osmosis unit may desirably be increased to accommodate the increasing flow of draw solution expected to be provided to each successive unit. On the other hand, relative to the flow of the feed solution, the number of forward osmosis membranes within each forward osmosis unit will decrease in this configuration. Stated another way, for process 300, forward osmosis unit 312 comprises a greater number of membranes than forward osmosis unit 302, forward osmosis unit 322 comprises a greater number of membranes than forward osmosis unit 312, and so forth.

Generally speaking, each forward osmosis unit desirably comprises one or multiple forward osmosis membranes, and more particularly, may desirably comprise one or greater than 1, greater than 100, greater than 1,000, greater than 4,000, or 100,000 membranes, of any shape and configuration, or in a combination of shapes and configurations.

The particular number of membranes to be used within each forward osmosis unit can depend on a number of related variables, including, e.g., the water flow across each membrane, the osmotic pressure differential between the feed and draw solutions, the total surface area of the membranes to be used, process temperature, fouling rate, etc. For process 300, in that embodiment wherein the flow rate provided to one or more downstream process(es) is desirably 25 t/h, with the above assumed concentrations and flow rates to each forward osmosis unit, forward osmosis unit 302 may desirably comprise 50 or greater forward osmosis membranes, forward osmosis unit 312 may desirably comprise 70 or greater membranes. Forward osmosis unit 322 may, in turn, comprise greater than 100 membranes. Forward osmosis unit 332 may desirably comprise greater than 130 membranes and forward osmosis unit 342 may desirably comprise greater than 170 membranes. In that embodiment of process 300 wherein the flow rate provided to one or more downstream processes is desirably 5000 t/h, forward osmosis unit 302 may desirably comprise 10500 or greater forward osmosis membranes, forward osmosis unit 312 may desirably comprise 14500 or greater membranes. Forward osmosis unit 322 may, in turn, comprise greater than 20500 membranes. Forward osmosis unit 332 may desirably comprise greater than 27000 membranes and forward osmosis unit 342 may desirably comprise greater than 34000 membranes.

Although the configuration shown in FIG. 3 can generally require more forward osmosis units and/or membranes than, e.g., FIG. 2, additional bore holes to the brine mine are generally not required, i.e., the draw stream outflow provided by the configuration shown by FIG. 3 is less than that provided by the configuration shown in FIG. 2. The use of a forward osmosis configuration as shown by, or similar to, FIG. 2 can also be especially beneficial when disposal of the outgoing feed stream may be an issue, i.e., when the outgoing feed stream cannot be accommodated by a downstream process, or reintroduced into the source, e.g., well, river, ocean, sea, etc.

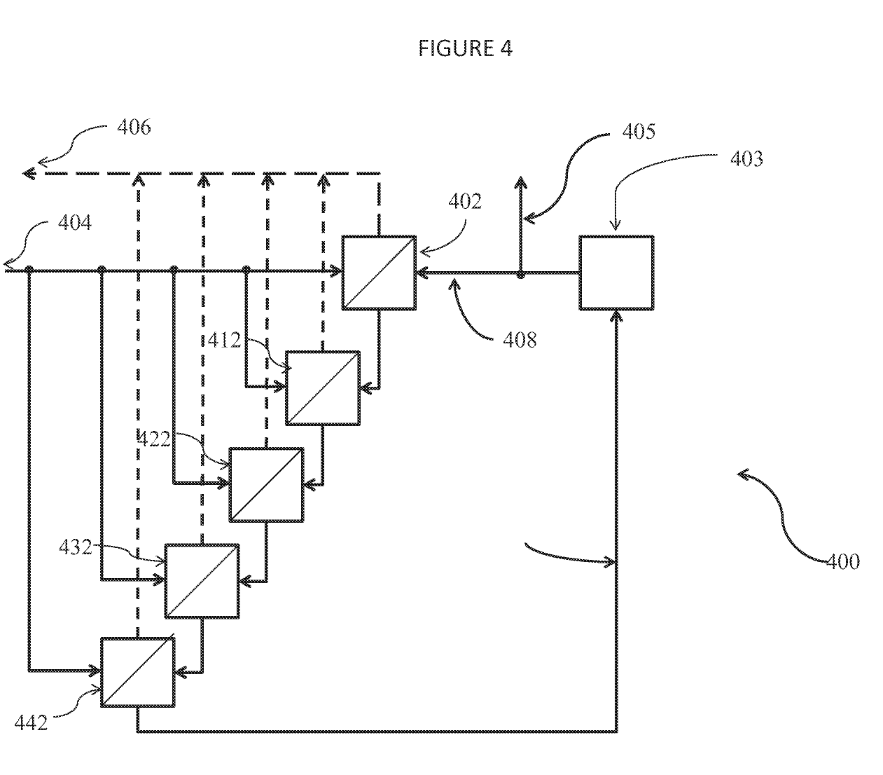

An additional exemplary process is shown in FIG. 4. Forward osmosis process 400 makes use of multiple forward osmosis units 402, 412, 422, 432 and 442. Process 400 thus differs from process 300 in that, while the draw stream is provided to the multiple forward osmosis units serially, the feed stream is provided to the multiple forward osmosis units in parallel. In process 400, the draw stream first contacts forward osmosis unit 402, while the same flow rate and concentration of the feed stream contacts each forward osmosis unit.

In operation of process 400, an aqueous feed stream is provided to the forward osmosis units 402, 412, 422, 432 and 442. The feed stream provided will desirably be an aqueous stream having a lower osmotic pressure than that provided by the draw stream as it is provided to forward osmosis units 402, 412, 422, 432, and 442. For exemplary purposes, process 400 contemplates the use of sea water having a salt concentration of 3.5% as the feed stream.

A draw stream comprising at least a portion 408 of the production stream from brine mine 403 is provided to forward osmosis unit 402. The draw stream will comprise the salt of interest, e.g., sodium chloride, typically at a concentration greater than that of the concentration of the salt within the draw stream as presented to each forward osmosis unit so that the osmotic pressure differential will allow the diffusion of water from the feed stream into the draw stream. The concentration of sodium chloride within the draw stream may, e.g., typically be greater than 10%, or greater than 15%, or greater than 20%, or even greater than about 25%. In process 400, the concentration of sodium chloride within the draw stream is contemplated to be 25%.

Within each forward osmosis unit of process 400, water is drawn from the feed stream into the draw stream, any impurities in the feed stream may be rejected by the membrane(s), and the concentration of salt within the feed stream may generally increase as the concentration of salt within the draw stream will generally increase. Because the feed stream is fed to the forward osmosis units in parallel, the concentration of salt within the feed stream fed to each forward osmosis unit will be the same. The concentration of salt within the draw stream is expected to decrease with each successive unit, so that the osmotic pressure between the feed and draw solutions is expected to be greatest within forward osmosis unit 402, where the salt concentration within the draw stream will be at its greatest. The osmotic pressure between the draw and feed solutions is expected to be at its lowest of process 400 within forward osmosis unit 442, where the concentration of salt within the draw stream will be at its lowest.

As with processes 200 and 300, the draw stream flow rate provided by conduit 408 may desirably depend upon the available bore holes and sizes of the particular brine mine being served by process 400. The draw stream flow rate may also desirably depend upon the demands of downstream processes for process streams produced by the mine To exemplify one low capacity brine mine, production capacity of brine mine 403 can be assumed to be 500 t/h of brine, with downstream processes requiring 150 t/h of this production, so that flow through conduit 408 to forward osmosis unit 402 is 350 t/h. A large capacity brine mine may produce, e.g., 9,300 t/h, of brine and desirably feed downstream processes 7500 t/h, thereby providing a flow through conduit 408 to forward osmosis unit 402 of 1,800 t/h.

As the draw stream draws water from the feed stream within each forward osmosis unit 402, 412, 422, 432 and 442, the water content, and desirably, the flow rate, thereof may increase within each forward osmosis unit 402, 412, 422, 432, and 442, so that the flow rate exiting via outlet 414 is greater than the flow rate of the draw stream entering forward osmosis unit 402 via conduit 408.

For the case where stream 405 is required to have a flow rate of 150 t/h with 25% salt content, then the flow rate of the draw stream will increase from 36 t/h and a salt content of 25% as it flows into forward osmosis unit 402, to a flow rate of 52 t/h and a salt content of 17.2% as it enters forward osmosis unit 412, to a flow rate of 73 t/h and a salt content of 12.3% as it enters forward osmosis unit 422, to a flow rate of 96 t/h and a salt content of 9.3% as it enters forward osmosis unit 432, to a flow rate of 122 t/h and a salt content of 7.3% as it enters forward osmosis unit 442. As it exits forward osmosis unit 442, the flow rate of the draw stream for this exemplary case may be 148 t/h, and the salt content thereof may be 6.1%.

For the case where stream 405 requires a flow rate of 7500 t/h with a 25% salt content, then the flow rate of the draw stream will increase from 1800 t/h and a salt content of 25% as it flows into forward osmosis unit 402, to a flow rate of 2613 t/h and a salt content of 17.2% as it enters forward osmosis unit 412, to a flow rate of 3660 t/h and a salt content of 12.3% as it enters forward osmosis unit 422, to a flow rate of 4830 t/h and a salt content of 9.3% as it enters forward osmosis unit 432, to a flow rate of 6120 t/h and a salt content of 7.3% as it enters forward osmosis unit 442. As it exits forward osmosis unit 442, the flow rate of the draw stream for this exemplary case may be 7425 t/h, and the salt content thereof may be 6.1%.

A flow rate of the feed stream is provided to forward osmosis units 402, 412, 422, 432 and 442 that will supply the necessary water to the draw stream to accommodate the requirements of brine mine 403 and the downstream process(es) fed by line 405. Because the feed stream is being fed to forward osmosis units 402, 412, 422, 432, and 442 in parallel, the flow rate into each unit is expected to be substantially the same. Any difference in flow rate of the feed as it exits each forward osmosis unit will thus be determined by the difference in draw stream concentration encountered by the feed stream within each forward osmosis unit.

For the exemplary embodiments where stream 405 is required to have a flow rate of 150 t/h with 25% salt content, then the water feed flow rate to unit 402 can be 108 t/h, to unit 412 157 t/h, to unit 422 219 t/h, to unit 432 289 t/h, to unit 442 367 t/h, the combined flow rate of the feed to all units (stream 404) is 1140 t/h and a salt content of 3.5%. The flow rate of the feed as it exits forward osmosis unit 402 is expected to be 91 t/h, while its salt content is expected to be 4.1%. Exiting forward osmosis unit 412, the feed stream is expected to have a salt content of 4.0% and a flow rate of 136 t/h. Exiting forward osmosis unit 422, the feed stream is expected to have a salt content of 3.9% and a flow rate of 196 t/h. Exiting forward osmosis unit 432, the feed stream is expected to have a salt content of 3.8% and a flow rate of 264 t/h. Exiting forward osmosis unit 442, the feed stream is expected to have a salt content of 3.8% and a flow rate of 341 t/h.

For the case where stream 405 requires a flow rate of 5000 t/h with a 25% salt content, the combined flow rate of the feed stream 404 is 38042 t/h and a salt concentration of 3.5%. The flow rate of the feed as it exits forward osmosis unit 402 is expected to be 3053 t/h, while its salt content is expected to be 4.1%. Exiting forward osmosis unit 412, the feed stream is expected to have a salt content of 4.0% and a flow rate of 4531 t/h. Exiting forward osmosis unit 422, the feed stream is expected to have a salt content of 3.9% and a flow rate of 6538 t/h. Exiting forward osmosis unit 432, the feed stream is expected to have a salt content of 3.8% and a flow rate of 8802 t/h. Exiting forward osmosis unit 442, the feed stream is expected to have a water content of 3.8% and a flow rate of 11367 t/h.

The number of forward osmosis membranes within each forward osmosis unit may desirably be increased to accommodate the increasing flow of draw solution expected to be provided to each successive unit. For process 400, with the above assumed concentrations and flow rates to each forward osmosis unit where stream 405 is to have 150 t/h of 25% salt content, forward osmosis unit 402 may desirably comprise 300 or greater forward osmosis membranes, forward osmosis unit 412 may desirably comprise 435 or greater membranes. Forward osmosis unit 422 may, in turn, comprise greater than 600 membranes. Forward osmosis unit 432 may desirably comprise 800 or greater membranes. Forward osmosis unit 442 may desirably comprise greater than 1000 membranes. In that embodiment where stream 405 is desirably provided with a flow rate of 5000 t/h 25% brine, forward osmosis unit 402 may desirably comprise 9900 or greater forward osmosis membranes, forward osmosis unit 412 may desirably comprise 14500 or greater membranes. Forward osmosis unit 422 may, in turn, comprise greater than 20000 membranes. Forward osmosis unit 432 may desirably comprise 26000 or greater membranes. Forward osmosis unit 442 may desirably comprise greater than 33500 membranes.

The embodiment shown by FIG. 4 is especially beneficial when used in connection with brine mining installations located close to a natural water source that can provide the feed flow in, and possibly accommodate the feed stream flow out. A brine mine installation located close to a downstream process that could utilize the feed stream outflow would also benefit from this embodiment. Advantageously, and because of the large concentration difference between the feed and draw streams at the last unit encountered by the feed stream, a larger flux rate of water through the membrane can be expected, therefore the number of needed forward osmosis elements will be somewhat less. Capital costs associated with this forward osmosis unit configuration will thus be less than the embodiment exemplified by FIG. 3.

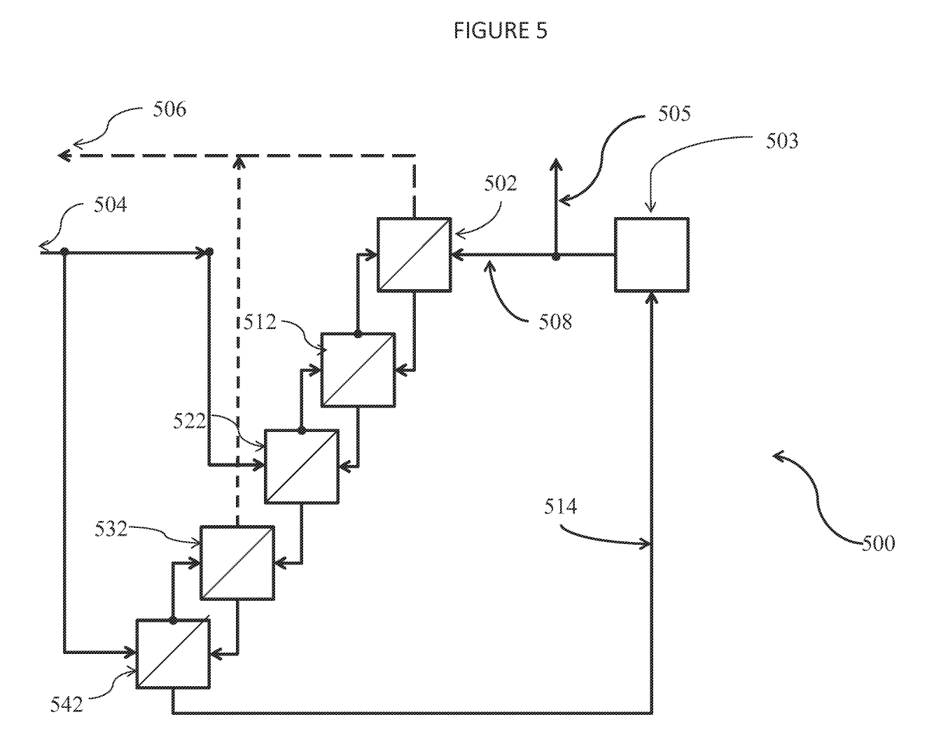

An additional exemplary process is shown in FIG. 5. Forward osmosis process 500 makes use of multiple forward osmosis units 502, 512, 522, 532 and 542. Process 500 thus differs from process 400 in that, while the draw stream is provided to the multiple forward osmosis units serially, the feed stream is provided to the multiple forward osmosis units in parallel and in series.

In operation of process 500, an aqueous feed stream is provided to the forward osmosis units 522 and 542. The feed stream provided will desirably be an aqueous stream having a lower osmotic pressure than that provided by the draw stream as it is provided to forward osmosis units 502, 512, 522, 532, and 542. For exemplary purposes, process 500 contemplates the use of sea water having a salt concentration of 3.5% as the feed stream.

A draw stream comprising at least a portion 508 of the production stream from brine mine 503 is provided to forward osmosis unit 502. The draw stream will comprise the salt of interest, e.g., sodium chloride, typically at a concentration greater than that of the concentration of the salt within the draw stream as presented to each forward osmosis unit so that the osmotic pressure differential will allow the diffusion of water from the feed stream into the draw stream. The concentration of sodium chloride within the draw stream may, e.g., typically be greater than 10%, or greater than 15%, or greater than 20%, or even greater than about 25%. In process 500, the concentration of sodium chloride within the draw stream is contemplated to be 25%.

Within each forward osmosis unit of process 500, water is drawn from the feed stream into the draw stream, any impurities in the feed stream may be rejected by the membrane(s), and the concentration of salt within the feed stream may generally increase as the concentration of salt within the draw stream will generally decrease. The feed stream is fed to the forward osmosis units 542 and 522. The concentrated feed stream exiting units 542 will then be fed to forward osmosis units 532. The concentrated feed stream exiting 522 will be fed to 512, concentrated more and then fed to 502. The concentration of salt within the draw stream is expected to decrease with each successive unit, so that the osmotic pressure between the feed and draw solutions is expected to be greatest within forward osmosis unit 502, where the salt concentration within the draw stream will be at its greatest. The osmotic pressure between the draw and feed solutions is expected to be at its lowest of process 500 within forward osmosis unit 542, where the concentration of salt within the draw stream will be at its lowest.

As with processes 200, 300 and 400, the draw stream flow rate provided by conduit 508 may desirably depend upon the available bore holes and sizes of the particular brine mine being served by process 500. The draw stream flow rate may also desirably depend upon the demands of downstream processes for process streams produced by the mine To exemplify one low capacity brine mine, production capacity of brine mine 503 can be assumed to be 125 t/h of brine, with downstream processes requiring 100 t/h of this production, so that flow through conduit 508 to forward osmosis unit 502 is 25 t/h. A larger capacity brine mine may produce, e.g., 1870 t/h, of brine and desirably feed downstream processes 1500 t/h, thereby providing a flow through conduit 508 to forward osmosis unit 502 of 370 t/h.

As the draw stream draws water from the feed stream within each forward osmosis unit 502, 512, 522, 532, and 542, the water content, and desirably, the flow rate, thereof may increase within each forward osmosis unit 502, 512, 522, 532, and 542, so that the flow rate exiting via outlet 514 is greater than the flow rate of the draw stream entering forward osmosis unit 502 via conduit 508.

For the case where stream 505 is required to have a flow rate of 100 t/h with 25% salt content, then the flow rate of the draw stream will increase from 25 t/h and a salt content of 25% as it flows into forward osmosis unit 502, to a flow rate of 36 t/h and a salt content of 17.3% as it enters forward osmosis unit 512, to a flow rate of 49 t/h and a salt content of 12.6% as it enters forward osmosis unit 522, to a flow rate of 65 t/h and a salt content of 9.5% as it enters forward osmosis unit 532, to a flow rate of 83 t/h and a salt content of 7.5% as it enters forward osmosis unit 542. As it exits forward osmosis unit 542, the flow rate of the draw stream for this exemplary case may be 100 t/h, and the salt content thereof may be 6.2%.

For the case where stream 505 requires a flow rate of 1500 t/h with a 25% salt content, then the flow rate of the draw stream will increase from 370 t/h and a salt content of 25% as it flows into forward osmosis unit 502, to a flow rate of 537 t/h and a salt content of 17.3% as it enters forward osmosis unit 512, to a flow rate of 740 t/h and a salt content of 12.6% as it enters forward osmosis unit 522, to a flow rate of 977 t/h and a salt content of 9.5% as it enters forward osmosis unit 532, to a flow rate of 1239 t/h and a salt content of 7.5% as it enters forward osmosis unit 542. As it exits forward osmosis unit 542, the flow rate of the draw stream for this exemplary case may be 1503 t/h, and the salt content thereof may be 6.2%.

A flow rate of the feed stream is provided to forward osmosis units 522 and 542 in parallel that will supply the necessary water to the draw stream to accommodate the requirements of brine mine 503 and the downstream process(es) fed by line 505. The feed stream is being fed to forward osmosis units 502, 512 in series from 522, and to 532, in series from 542, the flow rate into each unit is expected to be substantially the same. Any difference in flow rate of the feed as it exits each forward osmosis unit will thus be determined by the difference in draw stream concentration encountered by the feed stream within each forward osmosis unit.

For the exemplary embodiments where stream 505 is required to have a flow rate of 100 t/h with 25% salt content, then the water feed flow rate to unit 522 can be 148 t/h, to unit 542 can be 248 t/h, the combined flow rate of the fresh feed to units 522 and 542 (stream 504) is 396 t/h and a salt content of 3.5%. Exiting forward osmosis unit 542, the feed stream is expected to have a salt content of 3.8% and a flow rate of 230 t/h to be fed into 532. Exiting forward osmosis unit 532, the feed stream is expected to have a salt content of 4.1% and a flow rate of 178 t/h to be discharged. Exiting forward osmosis unit 522, the feed stream is expected to have a salt content of 3.9% and a flow rate of 132 t/h to be fed to 512. Exiting forward osmosis unit 512, the feed stream is expected to have a salt content of 4.5% and a flow rate of 94 t/h to be fed into 502. The flow rate of the feed as it exits forward osmosis unit 502 is expected to be 63 t/h, while its salt content is expected to be 5.3% to be discharged. The combined stream out of 532 and 502 (stream 506) is 321 t/h and a salt content of 4.3%.

For the case where stream 505 requires a flow rate of 1500 t/h with a 25% salt content, the combined flow rate of the feed stream 504 is 5937 t/h (2219 t/h to 522 and 3718 t/h to 542) and a salt concentration of 3.5%. Exiting forward osmosis unit 542, the feed stream is expected to have a salt content of 3.8% and a flow rate of 3454 t/h to be fed into 532. Exiting forward osmosis unit 532, the feed stream is expected to have a salt content of 4.1% and a flow rate of 2672 t/h to be discharged. Exiting forward osmosis unit 522, the feed stream is expected to have a salt content of 3.9% and a flow rate of 1983 t/h to be fed to 512. Exiting forward osmosis unit 512, the feed stream is expected to have a salt content of 4.5% and a flow rate of 1411 t/h to be fed into 502. The flow rate of the feed as it exits forward osmosis unit 502 is expected to be 944 t/h, while its salt content is expected to be 5.3% to be discharged. The combined stream out of 532 and 502 (stream 506) is 4810 t/h and a salt content of 4.3%.

The number of forward osmosis membranes within each forward osmosis unit may desirably be increased to accommodate the increasing flow of draw solution expected to be provided to each successive unit. For process 500, with the above assumed concentrations and flow rates to each forward osmosis unit where stream 505 is to have 100 t/h of 25% salt content, forward osmosis unit 502 may desirably comprise 200 or greater forward osmosis membranes, forward osmosis unit 512 may desirably comprise 300 or greater membranes. Forward osmosis unit 522 may, in turn, comprise greater than 400 membranes. Forward osmosis unit 532 may desirably comprise 540 or greater membranes. Forward osmosis unit 542 may desirably comprise greater than 690 membranes. In that embodiment where stream 505 is desirably provided with a flow rate of 1500 t/h 25% brine, forward osmosis unit 502 may desirably comprise 3080 or greater forward osmosis membranes, forward osmosis unit 512 may desirably comprise 4475 or greater membranes. Forward osmosis unit 522 may, in turn, comprise greater than 6150 membranes. Forward osmosis unit 532 may desirably comprise 8150 or greater membranes. Forward osmosis unit 542 may desirably comprise greater than 10300 membranes.

In addition to allowing the use of alternative water sources, and other efficiencies provided by the present process, the use of a forward osmosis step, or steps, may also provide the advantage of rejecting impurities from the feed solution, while providing water to the draw solution. For example, brine mining solutions may typically comprise varying concentrations of calcium, magnesium, sulfates, nickel, barium, strontium, manganese, aluminum, silica, iron, vanadium, chromium, molybdenum, titanium, flourides and the like, as well as many organic compounds. Preventing these contaminants entering the draw solution that is then reintroduced into the brine mine provides great benefit in that these contaminants will not then be introduced into downstream processes that utilize the production stream from the mine.

Nonetheless, in some embodiments, an additional treatment step may be carried out, either before or after the forward osmosis step to reduce the concentration of any such impurities in either the feed or draw solution. Reduction of any such impurities in the feed solution may be desirable, for example, to reduce or remove any possibility that they may migrate to the draw solution in the forward osmosis stop. The additional treatment step may comprise any treatment suitable for reducing the concentration of any of these, or other, undesirable impurities that may be present in the feed or draw solution. Examples of suitable treatments include, but are not limited to reverse osmosis, electrochemical reaction, ion exchange, dilution, filtration, or combinations of these.

While at least a portion of the production stream from the brine mine is subjected to a forward osmosis step, at least a portion of the production stream may also be provided to a downstream process. In such embodiments, this portion of the production stream may also be subjected to a treatment for the reduction of impurities prior to introduction into the downstream process, e.g., a chlor-alkali process.

In such processes, the presence of, e.g., calcium carbonate and/or magnesium hydroxide, in the production stream can be undesirable. The production stream may thus be reacted with sodium carbonate and/or caustic soda to precipitate the calcium carbonate and/or magnesium hydroxide. These relatively dense precipitates may carry other impurities, such as hydroxides of aluminum, silicates, etc., with them, and the resulting slurry of precipitates may be filtered and the precipitates removed. Further purification steps, typically comprising one or more ion exchange steps, or contact with active charcoal beds, may also be utilized to reduce the concentration of impurities in the production stream prior to introduction into the chlor-alkali process.

Once the production stream has been subjected to any additional purification steps desired, it may be provided to the chlor-alkali process for the production of chlorine. Any known chlor-alkali process may be utilized, and conventional chlor-alkali processes utilize one of three types of electrolytic cells—diaphragm cells, membrane cells and mercury cells. These three differ only in how chlorine gas and sodium hydroxide are prevented from mixing within the cell, and each generate chlorine at the anode, and hydrogen and sodium hydroxide in the cathode compartment, or in the case of the mercury cells, in a separate reactor. Those of ordinary skill in the art are familiar with the operational aspects of all three and capable of utilizing the production stream from the present process in any of them to produce the desired products. Chlorine, for example, is typically dried, purified, if necessary, compressed and liquefied into saleable or usable form.

In Examples 1-3, below, the different numbers of the same forward osmosis membranes are used within differing numbers of forward osmosis units arranged to provide parallel feeds, serial feeds, or a combination thereof, of the feed and draw streams.

### Example 1

351 t/h of a feed stream comprising sea water having a salt concentration of 3.5% and 117 t/h hour of a draw solution comprising 25% NaCl are provided to a single forward osmosis unit comprising 976 forward osmosis membranes (3.2 m² area, type FO_CTA, product 4040MS, commercially available from HTI™, Albany Oreg.) which exhibit a flux rate of 16 l/(h*m²)

The outgoing feed stream 206 contains 4.1 NaCl, at a flow rate of 301 t/h, while the outgoing draw stream 214 contains 17.5 NaCl at a flow rate of 167 t/h. This outgoing draw stream is then reintroduced into the brine mine to reconcentrate to 25% NaCl, obviating the need to reconcentrate the same with purchased salt or evaporation, thereby providing cost savings.

Additional flow that cannot be accommodated by the existing mine structure is stored, used in other processes, or appropriately disposed of. Or, additional bore holes are provided to accommodate the flow. In this case, about 50 t/h of fresh water is drawn from the forward osmosis unit to provide 67 t/h of brine having a salt concentration of 25% to a downstream process. One forward osmosis unit, having 976 membranes, is used, so that the capital costs for installation of the forward osmosis unit are minimized.

### Example 2

A feed stream comprising 3.5 wt. % NaCl and a draw stream comprising 25 wt. % NaCl are fed serially, and in counter current fashion, to five forward osmosis units comprising a total of 1438 forward osmosis membranes (type FO_CTA, product 4040MS, HTI™, Albany, Oreg.). The flow rates and salt concentration of the feed and draw streams at each forward osmosis unit, as well as the number of forward osmosis membranes used at each forward osmosis unit, are shown in Table 1, below, wherein the forward osmosis units are identified by reference to FIG. 3. The flux rates of the membranes in this example decreased from 16 l/(h*m²) in unit 302 to 14 l/(h*m²) in unit 312 to 12 l/(h*m²) in unit 322 to 10 l/(h*m²) in unit 332 to 8 l/(h*m²) in unit 342, caused by the decreasing salt concentration difference on the two sides of the membrane. The outgoing draw stream is introduced into a brine mine for reconcentration.

TABLE 1

| | | | | Draw | Draw | | | Feed | Feed |
|---|---|---|---|---|---|---|---|---|---|
| | | Draw | Draw | Stream | stream | Feed | Feed | Stream | Stream |
| | | Stream | Stream | flow | NaCl | Stream | Stream | flow | NaCl |
| Item | | flow | NaCl | rate | conc. | flow | NaCl | rate | conc. |
| in | # of FO | rate in | conc. | out | out | rate in | conc. | out | out |
| FIG. 3 | elements | [t/h] | In [%] | [t/h] | [%] | [t/h] | in [%] | [t/h] | [%] |
| 302 | 140 | 17 | 25.0 | 24 | 17.5 | 123 | 4.7 | 116 | 5.0 |
| 312 | 200 | 24 | 17.5 | 33 | 12.8 | 132 | 4.4 | 123 | 4.7 |
| 322 | 275 | 33 | 12.8 | 44 | 9.7 | 142 | 4.1 | 132 | 4.4 |
| 332 | 363 | 44 | 9.7 | 55 | 7.6 | 154 | 3.8 | 142 | 4.1 |
| 342 | 460 | 55 | 7.6 | 67 | 6.3 | 166 | 3.5 | 154 | 3.8 |

This example shows that the use of more forward osmosis membranes, in a serial configuration, can provide a lower flow rate and/or salt concentration of the outgoing draw solution. This flow may be more easily accommodated by some existing mine structures, e.g., so that additional bore holes, and/or other equipment cost, are not necessary. Also, this embodiment may reduce costs for pumping and/or disposal of the flow of the outgoing feed stream as compared to Example 1.

### Example 3

A feed stream comprising 3.5 wt. % NaCl is fed in parallel, and a draw stream comprising 25 wt. % NaCl is fed serially, to five forward osmosis units comprising a total of 1415 forward osmosis membranes (type FO_CTA, product 4040MS, HTI™, Albany Oreg.). The flow rates and salt concentration of the feed and draw streams at each forward osmosis unit, as well as the number of forward osmosis membranes used at each forward osmosis unit, are shown in Table 2, below, wherein the forward osmosis units are identified by reference to FIG. 4. The flux rates of the membranes in this example decreased from 17 l/(h*m²) in unit 402 to 15 l/(h*m²) in unit 412 to 12 l/(h*m²) in unit 422 to 10 l/(h*m²) in unit 432 to 8 l/(h*m²) in unit 442, caused by the decreasing salt concentration difference on the two sides of the membrane. The outgoing draw stream is introduced into a brine mine for reconcentration.

TABLE 2

| | | | | Draw | Draw | | | Feed | |
|---|---|---|---|---|---|---|---|---|---|
| | | Draw | Draw | Stream | Stream | Feed | Feed | Stream | |
| | | Stream | Stream | flow | NaCl | Stream | Stream | flow | Feed |
| | | flow | NaCl | rate | conc. | flow | NaCl | rate | conc. |
| Item | # of FO | rate in | conc. | out | out | rate in | conc. | out | out |
| in FIG. 4 | elements | [t/h] | in [%] | [t/h] | [%] | [t/h] | in [%] | [t/h] | [%] |
| 402 | 133 | 16 | 25.0 | 23 | 17.2 | 48 | 3.5 | 41 | 4.1 |
| 412 | 194 | 23 | 17.2 | 33 | 12.3 | 70 | 3.5 | 60 | 4.0 |
| 422 | 272 | 33 | 12.3 | 43 | 9.3 | 98 | 3.5 | 88 | 3.9 |
| 432 | 360 | 43 | 9.3 | 55 | 7.3 | 130 | 3.5 | 118 | 3.8 |
| 442 | 456 | 55 | 7.3 | 66 | 6.1 | 164 | 3.5 | 152 | 3.8 |

This embodiment requires a higher feed stream in flow, and produces a higher feed stream outflow, than that provided by the embodiment exemplified in Example 2. This embodiment is thus envisioned to be especially beneficial when used in connection with brine mining installations located close to a natural water source that can provide the feed flow in, and, since the salt concentration therein may be acceptable in some environments, possibly accommodate the feed stream flow out. A brine mine installation located close to a downstream process that could utilize the feed stream outflow would also benefit from this embodiment. Advantageously, and because of the large concentration difference between the feed and draw streams at the last unit encountered by the feed stream, a larger flux rate of water through the membrane can be expected, therefore the number of needed forward osmosis elements will be somewhat less. Capital costs associated with this forward osmosis unit configuration will also thus be less than the embodiment exemplified by Example 2.

### Example 4

A feed stream comprising 3.5 wt. % NaCl is fed in parallel and series, and a draw stream comprising 25 wt. % NaCl is fed serially, to five forward osmosis units comprising a total of 1431 forward osmosis membranes (type FO_CTA, product 4040MS, HTI™, Albany Oreg.). The flow rates and salt concentration of the feed and draw streams at each forward osmosis unit, as well as the number of forward osmosis membranes used at each forward osmosis unit, are shown in Table 3, below, wherein the forward osmosis units are identified by reference to FIG. 5. The flux rates of the membranes in this example decreased from 171/(h*m²) in unit 502 to 14 l/(h*m²) in unit 512 to 12 l/(h*m²) in unit 522 to 10 l/(h*m²) in unit 532 to 8 l/(h*m²) in unit 542, caused by the decreasing salt concentration difference on the two sides of the membrane. The outgoing draw stream is introduced into a brine mine for reconcentration.

TABLE 3

| | | | | Draw | Draw | | | Feed | |
|---|---|---|---|---|---|---|---|---|---|
| | | Draw | Draw | Stream | Stream | Feed | Feed | Stream | |
| | | Stream | Stream | flow | NaCl | Stream | Stream | flow | Feed |
| | | flow | NaCl | rate | conc. | flow | NaCl | rate | conc. |
| Item | # of FO | rate in | conc. | out | out | rate in | conc. | out | out |
| in FIG. 5 | elements | [t/h] | in [%] | [t/h] | [%] | [t/h] | in [%] | [t/h] | [%] |
| 502 | 137 | 16 | 25.0 | 23 | 17.3 | 49 | 4.5 | 42 | 5.3 |
| 512 | 199 | 24 | 17.3 | 33 | 12.6 | 72 | 3.9 | 63 | 4.5 |
| 522 | 274 | 33 | 12.6 | 43 | 9.5 | 99 | 3.5 | 88 | 3.9 |
| 532 | 362 | 43 | 9.5 | 55 | 7.5 | 130 | 3.8 | 119 | 4.1 |
| 542 | 459 | 55 | 7.5 | 67 | 6.2 | 165 | 3.5 | 154 | 3.8 |

This embodiment is between example 2 and 3 in flow rates, concentrations and number of elements. It has a reduced number of elements compared to example 2 without having to have as much feed flow as example 3.

Table 4 provides a summary Examples 1 to 4.

TABLE 4

| | | Feed | Draw | Draw | Feed | |
|---|---|---|---|---|---|---|
| | | Stream | stream | Stream | Stream | NaCl in |
| | # FO | flow rate in | flow rate | NaCl conc. | flow rate | feed stream |
| example | elements | [t/h] | out [t/h] | out | out [t/h] | outflow |
| 1 | 976 | 351 | 167 | 17.5% | 301 | 4.1% |
| 2 | 1438 | 166 | 67 | 6.3% | 116 | 5.0% |
| 3 | 1415 | 509 | 66 | 6.1% | 459 | 3.9% |
| 4 | 1431 | 264 | 67 | 6.2% | 214 | 4.3% |

As shown by Table 4, the forward osmosis configuration of Example 1 would require the drilling of additional bore holes to accommodate the 167 t/h draw stream flow out of the forward osmosis unit, assuming that the mine is setup to accommodate 50 t/h±20%. However, the configuration of Example 1 requires the fewest number of forward osmosis membranes and so capital costs may be saved.

Assuming the same mine capacity, example 2 would not require any additional holes to be drilled, but would require the capital cost expenditure of approximately 500 more membranes, or 47% more membranes than required by the configuration of Example 1. Example 2 shows the largest reduction in feed stream volume, however, the outgoing feed stream will thus also have the highest concentration of impurities.

Similarly, the configuration of Example 3 would not require the drilling of additional holes and requires a slightly lower amount of additional membranes as compared to Example 1 (calculated to be 44% in this example). Example 3 does produce the largest higher feed stream outflow, and consideration may need to be given during mine set up of appropriate means of use and/or disposal of this flow.

1. A brine mining process comprising providing at least a portion of at least one brine mining process stream to at least one forward osmosis unit.

2. The process of claim 1, wherein the at least one process stream is used as a draw stream in the forward osmosis unit.

3. The process of claim 2, wherein the draw stream is a spent anolyte or effluent brine stream from an electrochemical cell.

4. The process of claim 3, wherein the draw stream is further treated before use in the forward osmosis unit.

5. The process of claim 3, wherein the foreward osmosis unit comprises at least one membrane comprising cellulose triacetate.

6. The process of claim 1, wherein fresh water, salt water, one or more aqueous streams from the same, or one or more different, process(es), or a combination thereof, is used as a feed stream in the forward osmosis step.

7. The process of claim 1, wherein the process stream is thereafter introduced into the brine mine, provided to a downstream process, reprovided to the at least one forward osmosis unit, or a combination of these.

8. The process of claim 7, wherein the downstream process comprises a chlor-alkali process.

9. The process of claim 1, wherein the at least one brine mining process stream is provided to multiple forward osmosis units.

10. The process of claim 9, wherein the at least one brine mining process stream is provided to the multiple forward osmosis units in parallel.

11. The process of claim 9, wherein the at least one brine mining process stream is provided to the multiple forward osmosis units in series.

12. The process of claim 9, wherein the feed solutions are provided to the multiple forward osmosis units in parallel.

13. The process of claim 11, wherein the draw and feed solutions are provided to the multiple forward osmosis units in a counter-current arrangement.

14. The process of claim 13, wherein two or more feed solutions are provided to the multiple forward osmosis units in parallel.

15. The process of claim 12, wherein two or more draw solutions are provided to the multiple forward osmosis units in parallel.

16. The process of claim 1, wherein at least one forward osmosis unit comprises more than one forward osmosis membrane.

17. The process of claim 16, wherein the number of membranes per forward osmosis unit is adjusted to accommodate the flow rate to each unit.

18. The process of claim 16, wherein the flow rate of either or both the feed or draw solutions is adjusted between at least two forward osmosis units.

19. The process of claim 16, wherein the flow rate is adjusted by a partial purge of either or both the feed or draw solutions.

20. (canceled)

21. The process of claim 20, wherein the additional treatment step comprises reverse osmosis, electrochemical reaction, ion exchange, dilution, filtration or a combination of any number of these.

22. The process of any one of claim 1, wherein the brine comprises sodium chloride, potassium chloride, magnesium chloride, sodium carbonate, sodium bicarbonate, sodium sulfate, or combinations of these.

23. (canceled)
